(19) United States
(12) Patent Application Publication
(10) Pub. No.: US 2026/0183095 A1
(43) Pub. Date: Jul. 2, 2026

(54) TOOTHBRUSH HEAD AND TOOTHBRUSH

(71) Applicant: Shenzhen Baolijie Technology Co., Ltd., Shenzhen (CN)

(72) Inventors: Huajie He, Shenzhen (CN); Shuai Yuan, Shenzhen (CN); Mingfeng He, Shenzhen (CN)

(21) Appl. No.: 19/192,228

(22) Filed: Apr. 28, 2025

(30) Foreign Application Priority Data
Jan. 2, 2025 (CN) 202510002241.8

(51) Int. Cl. A61C 17/22; A46B 5/00; A46B 13/02

(52) U.S. Cl. CPC A61C 17/222; A46B 5/0095; A46B 13/02

(57) ABSTRACT

A toothbrush head includes a toothbrush head body. An end of the toothbrush head body defines a first cavity, a bristle embedded head is disposed in the first cavity, a brush head bracket is disposed below the bristle embedded head and located in the first cavity, and the brush head bracket is formed with a notch. A first inner shaft is disposed at a side of the brush head bracket, and a second inner shaft is disposed at an end of the first inner shaft. Two sides of the end of first inner shaft are provided with first protrusions, and an end of the second inner shaft is formed with a first groove. Two sides of the first groove are formed with third through holes, the end of the first inner shaft is arranged in the first groove, and the first protrusions are arranged in the third through holes, respectively.

### TECHNICAL FIELD

The disclosure relates to the field of toothbrush, and particularly to a toothbrush head and a toothbrush.

### BACKGROUND

There is a wide variety of toothbrush handle designs available on the market. However, the range of toothbrush heads that can be attached to most handles is quite limited, resulting in low universality. For consumers, this means that when they need to replace the toothbrush head, their options are significantly reduced. Additionally, due to the iteration of production models, some toothbrush head models are no longer produced by manufacturers. Therefore, it is necessary to design a highly universal toothbrush head to expand the range of choices for consumers and to be compatible with various toothbrush handle designs.

### SUMMARY

A purpose of the disclosure is to provide a new toothbrush head and a toothbrush with stable and reliable connection, low operating noise, and a good consumer experience.

To achieve above purpose, the disclosure provides a toothbrush head, the toothbrush head includes a toothbrush head body. An end of the toothbrush head body defines a first cavity, a bristle embedded head is disposed in the first cavity, a brush head bracket is disposed below the bristle embedded head and located in the first cavity, and the brush head bracket is formed with a notch. A first inner shaft is disposed at a side of the brush head bracket, and a second inner shaft is disposed at an end of the first inner shaft. Two sides of the end of the first inner shaft are provided with first protrusions, and an end of the second inner shaft is formed with a first groove. Two sides of the first groove are formed with third through holes, the end of the first inner shaft is arranged in the first groove, and the first protrusions are arranged in the third through holes, respectively. A spring is sleeved on a connection between the first inner shaft and the second inner shaft.

In an embodiment, an upper surface of the brush head bracket is formed with a first contact ring, and a lower surface of the brush head bracket is formed with a second contact ring. A first inclined surface is formed on a side of the first contact ring, and a second inclined surface is formed on a side of the second contact ring. The bristle embedded head and the brush head bracket are in contact with each other at the first contact ring, the second contact ring, the first inclined surface and the second inclined surface.

In an embodiment, an end of the bristle embedded head is formed with a first limiting block, a positioning column is disposed on the first limiting block, and the first inner shaft is provided with a connecting column. The connecting column is formed with a positioning hole, and the positioning column is arranged in the positioning hole.

In an embodiment, the toothbrush head body is formed with a first through hole in communication with the first cavity, and the brush head bracket is formed with a second through hole. A nail is disposed in the first through hole and the second through hole, and two sides of the brush head bracket are formed with second limiting blocks.

In an embodiment, another end of the bristle embedded head is provided with a bristle embedded head base, a first sleeve is disposed between the bristle embedded head base and the first limiting block, and a central nail is disposed in the first sleeve. The brush head bracket is formed with a fourth through hole, and the first sleeve is arranged in the fourth through hole. A second sleeve is disposed on an end of the central nail and located on a bottom surface of the first cavity.

In an embodiment, a tail cover is disposed on another end of the toothbrush head body, the tail cover is formed with a buckling portion, and the buckling portion is a cantilever structure.

In an embodiment, an outer side of the first sleeve is provided with a third limiting block, a side of the fourth through hole is formed with a limiting groove, and the third limiting block is disposed in the limiting groove.

In an embodiment, another end of the second inner shaft is provided with a third inclined surface.

In an embodiment, the toothbrush head body defines a second cavity located at a side of the first cavity, the second cavity is in communication with the first cavity, and the first inner shaft and the second inner shaft are disposed in the second cavity.

In an embodiment, a toothbrush includes the toothbrush head mentioned above.

Therefore, the disclosure adopts the above-mentioned new toothbrush head and toothbrush, and the technical effects are as follows.
(1) By providing the first inclined surface, the second inclined surface, and the third inclined surface can reduce the generation of operating noise during use.
(2) A structure formed by the first inner shaft, the second inner shaft, and the spring allows the spring to perform a piston reciprocating motion. After being compressed under force, the spring rebounds to provide a counterthrust.
(3) After the first inner shaft and the second inner shaft are assembled together, the first protrusions on the first inner shaft are assembled into the third through holes of the second inner shaft to act as a fixing center and allow rotation. This structure can reduce damage to the gums during brushing teeth.

### BRIEF DESCRIPTION OF DRAWINGS

FIG. 1 illustrates a schematic diagram of a toothbrush head of the disclosure.

FIG. 2 illustrates a schematic structural diagram of a first inner shaft and a second inner shaft of the disclosure.

FIG. 3 illustrates a schematic structural diagram of a bristle embedded head and a brush head bracket of the disclosure.

FIG. 4 illustrates a schematic structural diagram of the brush head bracket of the disclosure.

FIG. 5 illustrates a schematic structural diagram of a tail cover of the disclosure.

FIG. 6 illustrates a partially schematic structural diagram of a toothbrush head body of the disclosure.

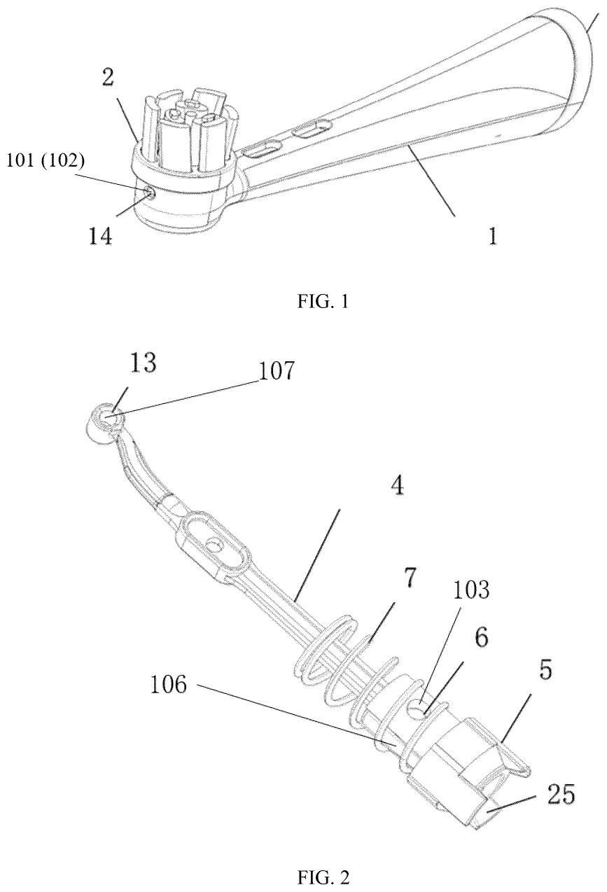

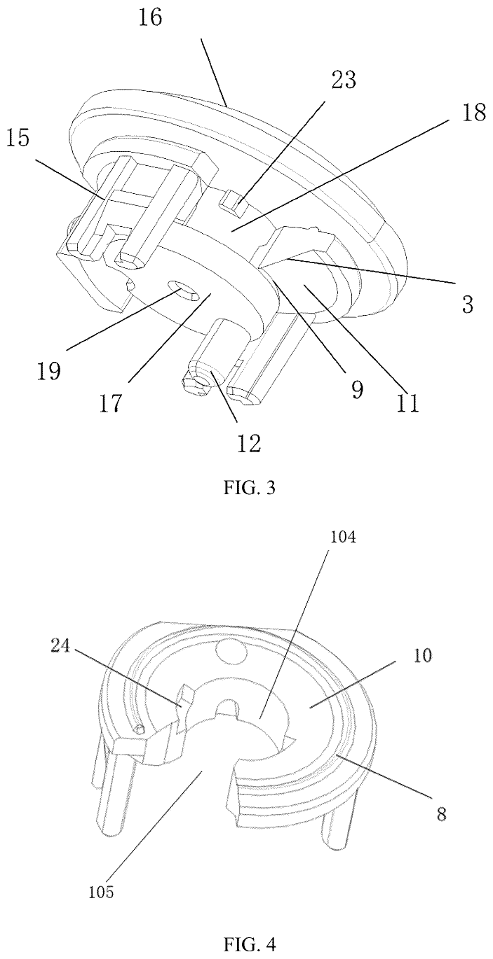

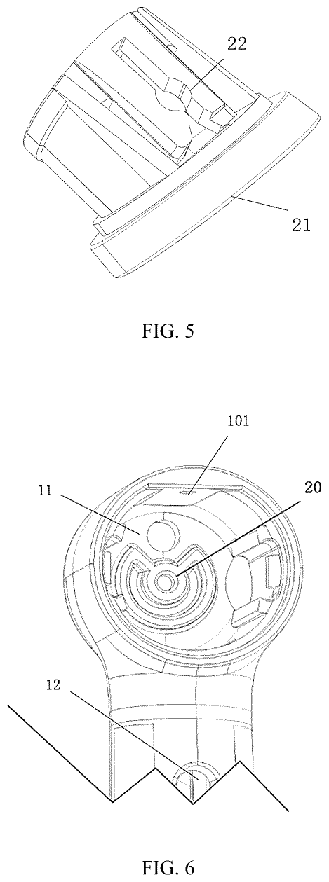

### DESCRIPTION OF REFERENCE NUMERALS

1. toothbrush head body; 11. first cavity; 101. first through hole; 102. second through hole; 103. third through hole; 104. fourth through hole; 105. notch; 106. first groove; 107. positioning hole; 12. second cavity; 2. bristle embedded head; 3. brush head bracket; 4. first inner shaft; 5. second inner shaft; 6. first protrusion; 7. spring; 8. first contact ring; 9. second contact ring; 10. first inclined surface; 11. second inclined surface; 12. positioning column; 13. connecting column; 14. head nail; 15. second limiting block; 16. bristle embedded head base; 17. first limiting block; 18. first sleeve; 19. central nail; 20. second sleeve; 21. tail cover; 22. buckle groove; 23. third limiting block; 24. limiting groove; 25. third inclined surface.

### DETAILED DESCRIPTION OF EMBODIMENTS

The following provides further explanation of the technical solution of the disclosure through the attached drawings and embodiments.

Unless otherwise defined, the technical or scientific terms used in the disclosure shall have the usual meanings as understood by those skilled in the art to which the disclosure belongs.

An embodiment of the disclosure provides a toothbrush head, and the toothbrush head includes a toothbrush head body 1. An end of the toothbrush head body 1 defines a first cavity 11, a bristle embedded head 2 is disposed in the first cavity 11, a brush head bracket 3 is disposed below the bristle embedded head 2 and located in the first cavity 11, and the brush head bracket 3 is formed with a notch 105 for easy installation of the bristle embedded head 2. The notch 105 of the brush head bracket 3 corresponds to a certain rotation angle, for example, a rotation of 83° may be achievable, which increases the flexibility and coverage during brushing teeth.

A first inner shaft 4 is disposed at a side of the brush head bracket 3, and a second inner shaft 5 is disposed at an end of the first inner shaft 4. The toothbrush head body 1 defines a second cavity 12 located at a side of the first cavity 11, the first cavity 11 is in communication with the second cavity 12, and the first inner shaft 4 and the second inner shaft 5 are disposed in the second cavity 12. The toothbrush head 1 wraps around the first inner shaft 4 and the second inner shaft 5.

Two sides of the end of the first inner shaft 4 are provided with first protrusions 6, and an end of the second inner shaft 5 is formed with a first groove 106. Two sides of the first groove 106 are formed with third through holes 103, the end of the first inner shaft 4 is arranged in the first groove 106, and the first protrusions 6 are arranged in the third through holes 103, respectively. A spring 7 is sleeved on a connection between the first inner shaft 4 and the second inner shaft 5.

After the first inner shaft 4 and the second inner shaft 5 are assembled together, the first protrusions 6 on the first inner shaft 4 are assembled into the third through holes 103 of the second inner shaft 5 to act as a fixing center and allow rotation.

By transforming a cooperative motion of the first inner shaft 4 and the second inner shaft 5 into a circular motion associated with the brush head, the transmission of force is balanced and thus the motion does not damage gums, and moreover the large angle rotation can improve the cleaning effect.

An upper surface of the brush head bracket 3 is formed with a first contact ring 8, and a lower surface of the brush head bracket 3 is formed with a second contact ring 9. A first inclined surface 10 is disposed on a side of the first contact ring 8, and a second inclined surface 11 is disposed on a side of the second contact ring 9. The bristle embedded head 2 and the brush head bracket 3 are in contact with each other at the first contact ring 8, the second contact ring 9, the first inclined surface 10 and the second inclined surface 11. Another end of the second inner shaft 5 is provided with a third inclined surface 25.

The first inclined surface 10, the second inclined surface 11, and the third inclined surface 25 are used to reduce the generation of operating noise during use.

The contact surface between the bristle embedded head 2 and the brush head bracket 3 is a small local contact design, which is specifically realized by the first contact ring 8 and the second contact ring 9.

An end of the bristle embedded head 2 is provided with a first limiting block 17, a positioning column 17 is disposed on the first limiting block 17, and the first inner shaft 4 is provided with a connecting column 13. The connecting column 13 is formed with a positioning hole 107, and the positioning column 12 is arranged in the positioning hole 107.

The toothbrush head body 1 is formed with a first through hole 101 in communication with the first cavity 11, and the brush head bracket 3 is formed with a second through hole 102. A nail 14 is disposed in the first through hole 101 and the second through hole 102, and second limiting blocks 15 are disposed on two sides of the brush head bracket 3. An assembly method is as follows. The center nail 19 is assembled into the fourth through hole 104 of the brush head bracket 3, and the bristle embedded head 2 is assembled into a side of the brush head bracket 3 to cooperate with the center nail 19. Then, the assembled bristle embedded head 2 and the assembled center nail 19 are pressed together into the second sleeve 20 of the brush head bracket 3, and the a nail 14 are inserted to the first through hole 101 and the second through hole 102 to fix the bristle embedded head 2 and the brush head bracket 3.

The nail 14 and the center nail 19 cooperate with each other to connect the brush head bracket 3 and the bristle embedded head 2 onto the toothbrush head body 1.

Another end of the bristle embedded head 2 is provided with a bristle embedded head base 16, a first sleeve 18 is disposed between the bristle embedded head base 16 and the first limiting block 17, and a central nail 19 is disposed in the first sleeve 18. The brush head bracket 3 is formed with a fourth through hole 104, and the first sleeve 18 is arranged in the fourth through hole 104. A second sleeve 20 is disposed on an end of the central nail 19 and located on a bottom surface of the first cavity 11.

A tail cover 21 is disposed on another end of the toothbrush head body 1, and the tail cover 21 is formed with a buckling portion 22. The buckling portion 22 is a cantilever structure, which is easy for users to grip and disassemble.

An outer side of the first sleeve 18 is provided with a third limiting block 23, a side of the fourth through hole 104 is formed with a limiting groove 24, and the third limiting block 23 is disposed in the limiting groove 24, which is easy to limit the rotation of the bristle embedded head 2 and brush head bracket 3.

Another embodiment of the disclosure provides a toothbrush, and the toothbrush includes the toothbrush head as described in any one of the above embodiments. In some embodiments, it is well-known to the skilled person in the art that the toothbrush usually further includes a toothbrush handle detachably connected to the toothbrush head.

An assembly process of toothbrush head body 1 is as follows.

The toothbrush head body 1 is fixed on a fixture, the bristle embedded head 2 is inserted into the brush head bracket 3, and the center nail 19 is assembled into a central hole at the bottom of the bristle embedded head 2. After the bristle embedded head 2, the brush head bracket 3, and the center nail 19 are assembled, thereby forming a single component assembly for later use. Next, the first inner shaft 4 is inserted into the first groove 106 of the second inner shaft 5, and then the spring 7 is installed from the top to the bottom of the first inner shaft 4. After assembly, the spring 7, the first inner shaft 4, and the second inner shaft 5 form an inner shaft component.

Then, the assembled inner shaft component (consisting of the spring 7, the first inner shaft 4, and the second inner shaft 5) is inserted into the toothbrush head body 1 from the bottom up to an upper opening of the toothbrush head body 1. The assembled inner shaft component is positioned through the positioning hole 107 on the toothbrush head body 1. After that, the bristle embedded head 2, the brush head bracket 3, and the center nail 19 are pressed together to assembly downward into the upper opening of the toothbrush head body 1. Once completed, the nail 14 are inserted into a round hole (i.e., the first through hole 101 and the second through hole 102) at the top of the toothbrush head body 1. Finally, the tail cover 21 is assembled onto the lower end of the toothbrush head body 1 to complete the assembly process.

Therefore, the disclosure adopts the above-mentioned new toothbrush head and toothbrush, with stable and reliable connection, low operating noise, and providing a good consumer experience.

It should finally be noted that: the above embodiments are only used to illustrate the technical solution of the disclosure and are not intended to limit it. Although the disclosure has been described in detail with reference to the specific embodiments, those skilled in the art should understand that they can still modify the technical solution of the disclosure or make equivalent substitutions. Such modifications or equivalent substitutions shall not cause the modified technical solution to depart from the spirit and scope of the technical solution of the disclosure.

What is claimed is:

1. A toothbrush head comprising a toothbrush head body, wherein an end of the toothbrush head body defines a first cavity, a bristle embedded head is disposed in the first cavity, a brush head bracket is disposed below the bristle embedded head and located in the first cavity, and the brush head bracket is formed with a notch;
wherein a first inner shaft is disposed at a side of the brush head bracket, and a second inner shaft is disposed at an end of the first inner shaft;
wherein two sides of the end of the first inner shaft are provided with first protrusions, and an end of the second inner shaft is formed with a first groove; two sides of the first groove are formed with first through holes, the end of the first inner shaft is arranged in the first groove, and the first protrusions are arranged in the first through holes respectively; a spring is sleeved on a connection between the first inner shaft and the second inner shaft.

2. The toothbrush head as claimed in claim 1, wherein an upper surface of the brush head bracket is formed with a first contact ring, and a lower surface of the brush head bracket is formed with a second contact ring; a first inclined surface is formed on a side of the first contact ring, and a second inclined surface is formed on a side of the second contact ring; the bristle embedded head and the brush head bracket are in contact with each other at the first contact ring, the second contact ring, the first inclined surface and the second inclined surface.

3. The toothbrush head as claimed in claim 1, wherein an end of the bristle embedded head is formed with a first limiting block, a positioning column is disposed on the first limiting block, and the first inner shaft is provided with a connecting column; the connecting column is formed with a positioning hole, and the positioning column is arranged in the positioning hole.

4. The toothbrush head as claimed in claim 1, wherein the toothbrush head body is formed with a second through hole in communication with the first cavity, and the brush head bracket is formed with a third through hole; a nail is disposed in the second through hole and the third through hole, and two sides of the brush head bracket are formed with second limiting blocks.

5. The toothbrush head as claimed in claim 3, wherein another end of the bristle embedded head is provided with a bristle embedded head base, a first sleeve is disposed between the bristle embedded head base and the first limiting block, and a central nail is disposed in the first sleeve; the brush head bracket is formed with a fourth through hole, and the first sleeve is arranged in the fourth through hole; a second sleeve is disposed on an end of the central nail and located on a bottom surface of the first cavity.

6. The toothbrush head as claimed in claim 1, wherein a tail cover is disposed on another end of the toothbrush head body, the tail cover is formed with a buckling portion, and the buckling portion is a cantilever structure.

7. The toothbrush head as claimed in claim 5, wherein an outer side of the first sleeve is provided with a third limiting block, a side of the fourth through hole is formed with a limiting groove, and the third limiting block is disposed in the limiting groove.

8. The toothbrush head as claimed in claim 1, wherein another end of the second inner shaft is provided with a third inclined surface.

9. The toothbrush head as claimed in claim 1, wherein the toothbrush head body defines a second cavity located at a side of the first cavity, the second cavity is in communication with the first cavity, and the first inner shaft and the second inner shaft are disposed in the second cavity.

10. A toothbrush comprising the toothbrush head as claimed in claim 1.
